(19) United States
(12) Patent Application Publication
(10) Pub. No.: US 2016/0098180 A1
(43) Pub. Date: Apr. 7, 2016

(54) PRESENTATION OF ENLARGED CONTENT ON COMPANION DISPLAY DEVICE

(71) Applicant: SONY CORPORATION, Tokyo (JP)

(72) Inventors: Peter Shintani, San Diego, CA (US); Brant Candelore, San Diego, CA (US)

(21) Appl. No.: 14/503,819

(22) Filed: Oct. 1, 2014

(51) Int. Cl. G06F 3/0484

(52) U.S. Cl. CPC G06F 3/04847; G06F 3/04842

(57) ABSTRACT

Content from an audio video display device is communicated to a nearby companion device on whose screen a user-selected portion of the content is presented, magnified from its presentation on the AVDD.

### FIELD OF THE INVENTION

The application relates generally to presenting enlarged content on a companion display device.

### BACKGROUND OF THE INVENTION

A computer ecosystem, or digital ecosystem, is an adaptive and distributed socio-technical system that is characterized by its sustainability, self-organization, and scalability. Inspired by environmental ecosystems, which consist of biotic and abiotic components that interact through nutrient cycles and energy flows, complete computer ecosystems consist of hardware, software, and services that in some cases may be provided by one company, such as Sony. The goal of each computer ecosystem is to provide consumers with everything that may be desired, at least in part services and/or software that may be exchanged via the internet. Moreover, interconnectedness and sharing among elements of an ecosystem, such as applications within a computing cloud, provides consumers with increased capability to organize and access data and presents itself as the future characteristic of efficient integrative ecosystems.

Two general types of computer ecosystems exist: vertical and horizontal computer ecosystems. In the vertical approach, virtually all aspects of the ecosystem are owned and controlled by one company, and are specifically designed to seamlessly interact with one another. Horizontal ecosystems, one the other hand, integrate aspects such as hardware and software that are created by other entities into one unified ecosystem. The horizontal approach allows for greater variety of input from consumers and manufactures, increasing the capacity tor novel innovations and adaptations to changing demands.

An example ecosystem that is pertinent here is a home entertainment ecosystem that includes a TV and various nearby display devices such as wireless communication devices.

### SUMMARY OF THE INVENTION

As understood, accommodations for the visually impaired include providing a zoom function that expands a portion of the content on a video display. However, this reduces the viewing experience for the non-visually impaired people who are watching the main display.

Accordingly, a device includes at least one computer readable storage medium with instructions executable by a processor to configure the processor to receive a selection of a region of content, being presented on a primary display device (PDD). The region of content is less than a full screen view of the content as presented on the PDD. The instructions when executed by the processor configure the processor to provide the selection to a companion device having a display such that the region of content can be presented on the display in full screen to zoom the region of content relative to presentation of the region of content on the PDD.

The processor may be in the PDD and the selection may be received from user input on the PDD. Or, the processor can be in the companion device and the selection received Irons user input on the companion device. In this example the instructions when executed by the processor configure the processor to present the region of content full screen on the companion device.

In examples, the instructions when executed by the processor configure the processor to, responsive to the selection, re-encode the region of contest and send the region of content re-encoded to the companion device. The processor may be in a set top box providing the content to both the PDD and the companion device. If desired, the instructions when executed by the processor can configure the processor to present on a display a prompt to select a region of content for zooming.

In another aspect, a computer readable storage medium (CRSM) that is not a carrier wave has instructions which when executed by a processor configure the processor to communicate content from a primary display device (PDD) to a nearby companion device on whose screen a user-selected portion of the content is presented, magnified from its presentation on the PDD.

In another aspect, a method includes presenting, on a primary display device (PDD), a video, and receiving a selection of a region of the video. The method also includes presenting the region full screen on a companion device.

The details of the present invention, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIGS. 2 and 3 are screen shots of the AVDD and companion device, respectively, illustrating aspects of present principles;

FIG. 4 is a flow chart of example logic according to aspects of present principles;

FIG. 5 is a screen shot of the companion device screen attendant to logic in FIG. 6; and

FIGS. 6 and 7 are flow charts of example logic according to present principles.

### DETAILED DESCRIPTION OF THE PREFERRED EMBODIMENT

This disclosure relates generally to computer ecosystems including aspects of consumer electronics (CE) device based user information in computer ecosystems. A system herein may include server and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, operating systems from Microsoft, or a Unix operating system, or operating systems produced by Apple Computer or Google. These operating environments may be used to execute one or more browsing programs, such as a browser made by Microsoft or Google or Mozilla or other browser program that can access web applications hosted by the Internet servers discussed below.

Servers may include one or more processors executing instructions that configure the servers to receive and transmit data over a network such as the Internet. Or, a client and server can be connected over a local intranet or a virtual private network.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical, disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

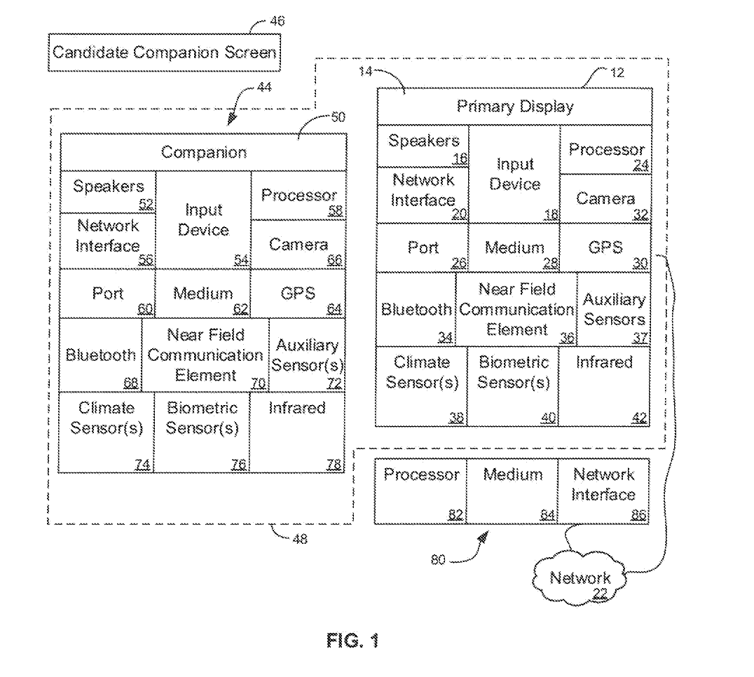

Now specifically referring to FIG. 1, an example ecosystem 10 is shown, which may include one or more of the example devices mentioned above and described further below in accordance with present principles. The first of the example devices included in the system 10 is an example primary display device, and in the embodiment shown is as audio video display device (AVDD) 12 such as but not limited to an Internet-enabled TV. Thus, the AVDD 12 alternatively may be an appliance or household item, e.g. computerized Internet enabled refrigerator, washer, or dryer. The AVDD 12 alternatively may also be a computerized internet enabled (“smart”) telephone, a tablet computer, a notebook computer, a wearable computerized device such as e.g. computerized Internet-enabled watch, a computerized Internet-enabled bracelet, other computerized internet-enabled devices, a computerized Internet-enabled music player, computerized Internet-enabled head phones, a computerized Internet-enabled implantable device such as an implantable skin device, etc. Regardless, it is to be understood that the AVDD 12 is configured to undertake present principles (e.g. communicate with other CE devices to undertake present principles, execute the logic described herein, and perform any other functions and/or operations described herein).

Accordingly, to undertake such principles the AVDD 12 can be established by some or all of the components shown in FIG. 1. For example, the AVDD 12 can include one or more displays 14 that may be implemented by a high definition or ultra-high definition flat screen and that may be touch-enabled for receiving user input signals via touches on the display. The AVDD 12 may include one or more speakers 16 for outputting audio in accordance with present principles, and at least one additional input device 18 such as e.g. an audio receiver/microphone for e.g. entering audible commands to the AVDD 12 to control the AVDD 12. The example AVDD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface. It is to be understood that the processor 24 controls the AVDD 12 to undertake present principles, including the other elements of the AVDD 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the AVDD 12 may also include one or more input ports 26 such as, e.g., a USB port to physically connect (e.g. using a wired connection) to another CE device and/or a headphone port to connect headphones to the AVDD 12 for presentation of audio from the AVDD 12 to a user through the headphones. The AVDD 12 may further include one or more tangible computer readable storage medium 28 such as disk-based or solid state storage. Also in some embodiments, the AVDD 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at winch the AVDD 12 is disposed in conjunction with the processor 24. However, it is to be understood that that another suitable position receiver other than a cellphone receiver, GPS receiver and/or altimeter may be used in accordance with present principles to e.g. determine the location of the AVDD 12 in e.g. all three dimensions.

Continuing the description of the AVDD 12, in some embodiments the AVDD 12 may include one or more cameras 32 that may be, e.g., a thermal imaging camera, a digital camera such as a webcam, and/or a camera integrated into the AVDD 12 and controllable by the processor 24 to gather pictures/images and/or video in accordance with present principles. Also included on the AVDD 12 may be a Bluetooth module 34 and other Near Field Communication (NFC) element 36 for communication with other devices using Bluetooth and/or NFC technology, respectively. An example NFC element can be a radio frequency identification (RFID) element. Note that the elements 34, 36, like other appropriate elements herein described, may be incorporated within a housing or chassis of the associated device or be provided as a universal serial bus (USB) 2/3 dongle device. With respect to the Bluetooth module 34, it may be implemented as a Bluetooth Low Energy (BLE) module and/or a Bluetooth 4.0 module that implements communications using one or more of BLE systems and/or standard Bluetooth systems.

In addition to the foregoing, the AVDD 12 may include one or more auxiliary sensors 37 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture commands), etc.) providing input to the processor 24. The AVDD 12 may include still other sensors such as e.g. one or more climate sensors 38 (e.g. barometers, humidity sensors, wind sensors, light sensors, temperature sensors, etc.) and/or one or more biometric sensors 40 providing input to the processor 24. In addition to the foregoing, it is noted that the AVDD 12 may also include an infrared (IR) transmitter and/or IR receiver and/or IR transceiver 42 such as an IR data association (IRDA) device. A battery (not shown) may be provided for powering the AVDD 12.

Still referring to FIG. 1, in addition to the AVDD 12, the system 10 may include one or more other CE device types that may establish companion screen devices for the primary display device established by the AVDD 12. In one example, a first companion screen device is established by a first CE device 44 while a second companion screen device may be established by a second CE device 46 which may include similar components as the first CE device 44 and hence will not be discussed in detail. In the example shown, only two CE devices 44, 46 are shown as companion screen devices, it being understood that only one companion screen device or more than two companion screen devices may be used.

In the example shown, to illustrate present principles all three devices 12, 44, 46 are assumed to be members of a home entertainment network in a dwelling or at least to be present in proximity to each other in a location such as a house. However, for illustrating present principles the first CE device 44 is assumed to be in the same room as the AVDD 12, bounded by walls illustrated by dashed lines 48, whereas the second CE device 46 is not in the same room.

The example non-limiting first CE device 44 may be established by any one of the above-mentioned devices and accordingly may have one or more of the components described below. Specifically, the first CE device 44 may include one or more displays 50 that may be touch-enabled for receiving user input signals via touches on the display. The first CE device 44 may include one or more speakers 52 for outputting audio in accordance with present principles, and at least one additional input device 54 such as e.g. an audio receiver/microphone for e.g. detecting audio from the AVDD 12 in accordance with present principles and/or entering audible commands to the first CE device 44 to control the device 44. The example first CE device 44 may also include one or more network interfaces 56 for communication over the network 22 under control of one or more CE device processors 58. Thus, the interface 56 may be, without limitation, a Wi-Fi transceiver, which is an example of a wireless computer network interface. It is to be understood that the processor 58 controls the first CE device 44 to undertake present principles, including the other elements of the first CE device 44 described herein such as e.g. controlling the display 50 to present images thereon and receiving input therefrom. Furthermore, note the network interface 56 may be, e.g., a wired or wireless modem or router, or other appropriate interface such as, e.g., a wireless telephony transceiver, or Wi-Fi transceiver as mentioned above, etc.

In addition to the foregoing, the first CE device 44 may also include one or more input ports 60 such as, e.g., a USB port to physically connect (e.g. using a wired connection) to another CE device and/or a headphone port to connect headphones to the first CE device 44 for presentation of audio from the first CE device 44 to a user through the headphones. The first CE device 44 may further include one or more tangible computer readable storage medium 62 such as disk-based or solid state storage. Also in some embodiments, the first CE device 44 can include a position or location receiver such as but not limited to a cellphone and/or GPS receiver and/or altimeter 64 that is configured to e.g. receive geographic position information from at least one satellite and/or cell tower, using triangulation, and provide the information to the CE device processor 58 and/or determine an altitude at which the first CE device 44 is disposed in conjunction with the CE device processor 58. However, it is to be understood that that another suitable position receiver other than a cellphone and/or GPS receiver and/or altimeter may be used in accordance with present principles to e.g. determine the location of the first CE device 44 in e.g. all three dimensions.

Continuing the description of the first CE device 44, it also includes one or more cameras 66 that may be, e.g., a thermal imaging camera, a digital camera such as a webcam, and/or a camera integrated into the first CE device 44 and controllable by the CE device processor 58 to gather pictures/images and/or video in accordance with present principles (e.g. to gather images presented on the display 14 of the AVDD 12).

Also included on the first CE device 44 may be a Bluetooth module 68 and other Near Field Communication (NFC) element 70 for communication with other devices using Bluetooth and/or NFC technology, respectively. An example NFC element can be a radio frequency identification (RFID) element. The Bluetooth module 68 may be substantially similar in configuration and use to the Bluetooth module 34 of the PDD.

Further still, the first CE device 44 may include one or more auxiliary sensors 72 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture commands), etc;) providing input to the CE device processor 58. The first CE device 44 may include still other sensors such as e.g. one or more climate sensors 74 (e.g. barometers, humidity sensors, wind sensors, light sensors, temperature sensors, etc.) and/or one or more biometric sensors 76 providing input to the CE device processor 58. In addition to the foregoing, it is noted that in some embodiments the first CE device 44 may also include an infrared (IR) transmitter and/or IR receiver and/or IR transceiver 78 such as an IR data association (IRDA) device. A battery (not shown) may be provided for powering the first CE device 44. The second CE device 46 may include some or all of the components shown for the CE device 44.

A server 80 is also shown as being a part of the system 10. The server 80 includes at least one server processor 82, at least one tangible computer readable storage medium 84 such as disk-based or solid state storage, and at least one network interface 86 that, under control of the server processor 82, allows for communication with the other devices of FIG. 1 over the network 22, and indeed may facilitate communication between servers and client devices in accordance with present principles. Note that the network interface 86 may be, e.g., a wired or wireless modem or router, Wi-Fi transceiver, or other appropriate interface such as, e.g., a wireless telephony transceiver. It is to be understood that the server 80 is capable of receiving data such as e.g. images of content and/or audiomarks of content, undertaking a search for ancillary content associated with the content from which the data was taken, and provide information regarding the ancillary content and/or provide the ancillary content itself to e.g. the CE device 44 in accordance with present principles.

Accordingly, in some embodiments the server 80 may be an Internet server, and may also include and perform “cloud” functions such that the devices of the system 10 may access a “cloud” environment via the server 80 in example embodiments.

Note that to initiate the logic described below, the AVDD 12 and/or companion device 44 may initiate a content detection application. Initiation of the application may occur e.g. automatically at startup of the device undertaking the present logic without further input from a user other than to initiate startup of the device itself, based on user invocation of the application based on e.g. selection of an icon associated with the application that is presented on a display of the device or even another device to e.g. remotely activate the application at the device, based on audio detected by the present device that is determined to not be a voice which the present device has been configured to recognize (e.g., not a voice of the present device's primary user), and/or based on detection using a camera on the present device of another CE device such as the AVDD 12 and/or a display of the AVDD 12 presenting (e.g. moving) images, etc.

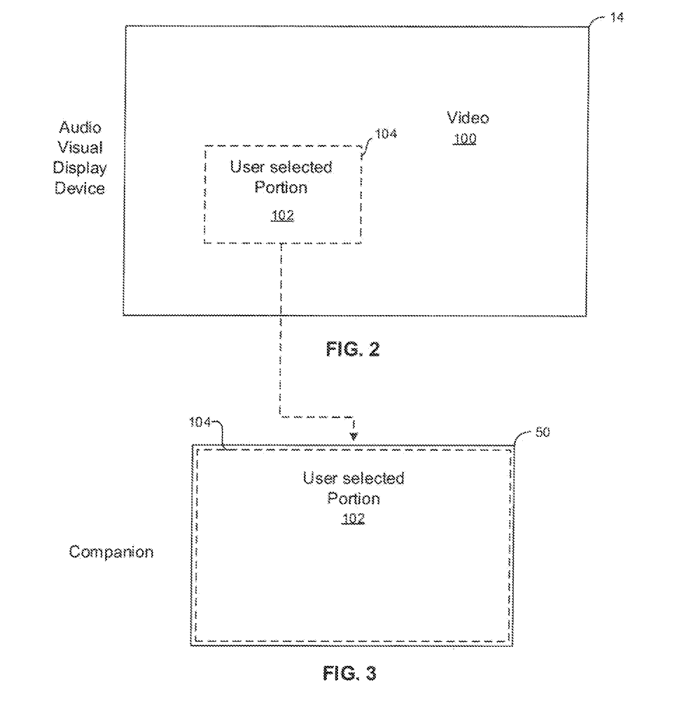

Now referring to a screen shot illustrated in FIG. 2, video 100 may be presented on the display of the AVDD 12. The screen shot demonstrates the capability of a visually impaired person to select a region of the main display that they wish to have enlarged. A user-selected portion 102 of the entire video 100 may be defined by an outline 104 under the control of the user. The user may define the outline 104 via manipulation of the display 14 with a finger, as in the case of touch-screen capable AVDD. The user may otherwise manipulate a remote device such as a mouse to define the outline 104.

The user-selected portion 102 as defined by the outline 104 may be enlarged, i.e. magnified, and presented on the display 50 of the companion device 44, as illustrated in FIG. 3. The enlarged user-selected portion 102 may be presented on the display 50 of the companion device 44 while the AVDD 12 continues to present the non-enlarged video 100 of its respective display 14. A visually impaired person would thus be able to view and enjoy the magnified media on the companion device 44 while the non-impaired person(s) can view the same media at normal size on the AVDD 12.

In order to accomplish the processes described in FIG. 2 and FIG. 3, the AVDD 12 can send a re-encoding, i.e. recompressed, of the user-selected portion 102 that is of interest to the companion device 44. The AVDD 12 may delay the media presented on the display 50 in order to accommodate a delay in processing by the companion device 44.

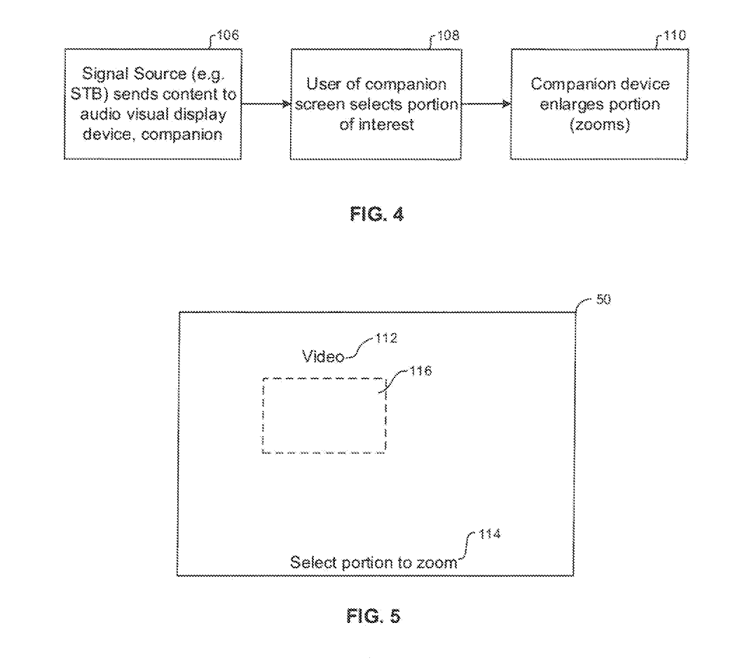

Example logic attendant to FIGS. 2 and 3 is illustrated by the flow chart of FIG. 4. At block 106, the AVDD 12 receives the video from a signal source and can delay presentation if desired. The signal source may be, although is not limited to, a broadcaster, headend, set-top box, a wireless transmitter such as Wi-Fi, or HDMI. The signal source in this embodiment will be referred to as a set-top box. The set-top box can use multicast IP to send content to both the AVDD 12 and the companion device 44 at the same time.

Moving to block 108 of FIG. 4, the AVDD 12 may re-code, or re-compress, the decoded video that was selected by the user and defined by outline 104. The re-coded portion may be sent to the companion device 44 by the AVDD 12 at block 110. The re-coded portion may be sent over a wireless connection. At block 112, the companion device 44 can present the re-coded portion of the media on the display 50 in a full-screen, enlarged format.

Now referring to the screen shot illustrated in FIG. 5, an area of a video 114 presented on display 50 of the companion device may be selected by user manipulation of the companion device 44 rather than by user manipulation of the AVDD 12. The media signal source may be sent to both the AVDD 12 and the companion device 44, and thus the video 114 may be the same media as the video 100 of the AVDD 12 described above in FIG. 2. The companion device may present to the user a prompt 116 that encourages the user to select a portion of the video 114 to zoom and enlarge. A companion device user-selected portion 118 is illustrated and may be defined by direct touch manipulation of the display 50, as in the case of a touch-screen display.

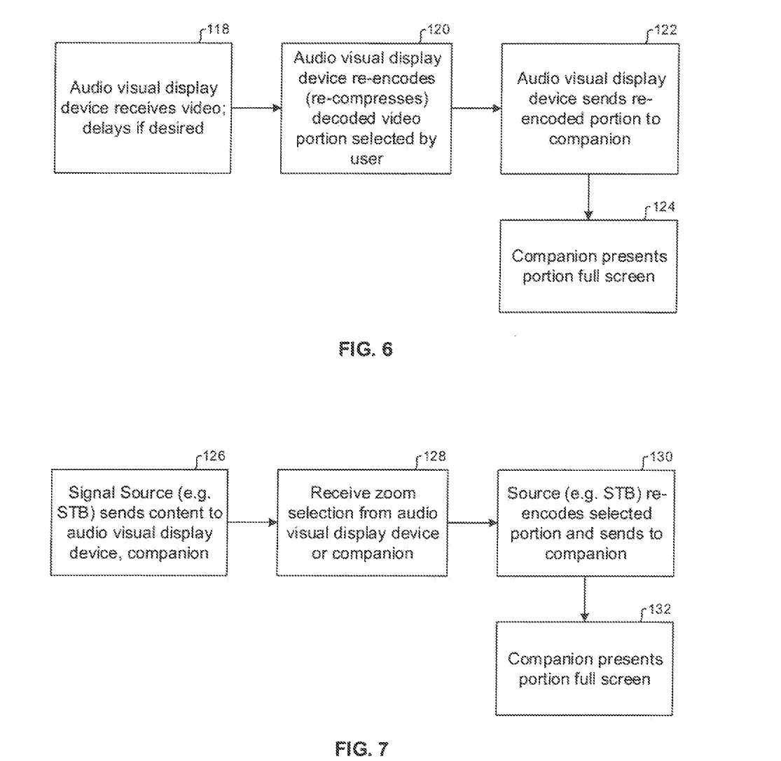

The logic attendant to FIG. 5 is illustrated in the flow chart of FIG. 6. The signal source, e.g. a set-top box, can send the media content simultaneously to the AVDD 12 and the companion device 44, as shown at block 120. Moving to block 122, the user of the companion device 44 may select a portion of interest 118. The companion device 44 can subsequently enlarge, i.e. zoom, the user-selected portion 118 at block 124.

Moving in reference to the flow chart illustrated in FIG. 7, the signal source, e.g. a set-top box, can simultaneously send the media content to both the AVDD 12 and the companion device 44, as described at block 126. The companion device 44 may be slaved to the AVDD 12 and may decode received media content in synchronization with the AVDD 12 decoding of the same media content.

The set-top box may receive either user-selected portion 102, 118 from either the AVDD 12 or the companion device 44, respectively, at block 128. In this embodiment, the signal source (here, the set-top box) re-codes the selected portion received from either the AVDD 12 or the companion device 44 and sends the re-coded portion to the companion device 44, as in block 130. The companion device 44 may then present the re-coded, enlarged portion on the display 50 in a full-screen format, as in block 132.

Regardless of the route of transmission of media content and the method of selecting a portion of a video to enlarge, a visually impaired user may view a magnified portion of a video in a full-screen format on a companion device while other users view the same video at a non-enlarged scale on an AVDD.

While the particular PRESENTATION OF ENLARGED CONTENT ON COMPANION DISPLAY DEVICE is herein shown and described in detail it is to be understood that the subject matter which is encompassed by the present invention is limited only by the claims.

What is claimed is:

1. A device, comprising:
at least one computer readable storage medium with instructions executable by a processor to configure the processor to:
receive a selection of a region of content being presented on a primary display device (PDD), the region of content being less than a full screen view of the content as presented on the PDD;
provide the selection to a companion device having a display such that the region of content can be presented on the display in full screen to zoom the region of content relative to presentation of the region of content on the PDD.

2. The device of claim 1, wherein the processor is in the PDD and the selection is received from user input on the PDD.

3. The device of claim 1, wherein the processor is in the companion device and the selection is received from user input on the companion device, the instructions when executed by the processor configuring the processor to present the region of content full screen on the companion device.

4. The device of claim 1, wherein the instructions when executed by the processor configure the processor to, responsive to the selection, re-encode the region of content and send the region of content re-encoded to the companion device.

5. The device of claim 4, wherein the processor is in a set top box providing the content to both the PDD and the companion device.

6. The device of claim 1, wherein the instructions when executed by the processor configure the processor to present on a display a prompt to select a region of content for zooming.

7. A computer readable storage medium (CRSM) that is not a carrier wave, the computer readable storage medium having instructions which when executed by a processor configure the processor to:
communicate content from a primary display device (PDD) to a nearby companion device on whose screen a user-selected portion of the content is presented, magnified from its presentation on the PDD.

8. The CRSM of claim 7, wherein the instructions when executed by the processor configure the processor to:
receive a selection of a region of content being presented on the PDD, the region of content being less than a full screen view of the content as presented on the PDD; and
provide the selection to the companion device, the companion device having a display such that the region of content is presented on the display in full screen to zoom the region of content relative to presentation of the region of content on the PDD.

9. The CRSM of claim 8, wherein the processor is in the PDD and the selection is received from user input on the PDD.

10. The CRSM of claim 8, wherein the processor is in the companion device and the selection is received from user input on the companion device, the instructions when executed by the processor configuring the processor to present the region of content full screen on the companion device.

11. The CRSM of claim 8, wherein the instructions when executed by the processor configure the processor to, responsive to the selection, re-encode the region of content and send the region of content re-encoded to the companion device.

12. The CRSM of claim 11, wherein the processor is in a set top box providing the content to both the PDD and the companion device.

13. The CRSM of claim 7, wherein the instructions when executed by the processor configure the processor to present on a display a prompt to select a region of content for zooming.

14. A method comprising:
presenting, on a primary display device (PDD), a video;
receiving a selection of a region of the video; and
presenting the region full screen on a companion device.

15. The method of claim 14, comprising:
decoding the video on the PDD and the companion device simultaneously, the video being sent from a source in synchronized streams to the respective PDD and companion device.

16. The method of claim 15, wherein the source is a set top box using multicast Internet Protocol (IP) to send the video to both the PDD and the companion device.

17. The method of claim 14, wherein the receiving is executed at the PDD, the PDD re-encoding the region and sending the region re-encoded to the companion device.

18. The method of claim 17, comprising delaying presentation of the video on the PDD to accommodate a delay in processing by the companion device.
